(19) United States
(12) Patent Application Publication
(10) Pub. No.: US 2006/0188623 A1
(43) Pub. Date: Aug. 24, 2006

(54) Meat tenderizing system

(76) Inventors: Ronn A. Houtz, Wichita, KS (US); Howard G. Dolezal JR., Derby, KS (US); Daniel L. Schaefer, Wichita, KS (US)

Correspondence Address: Christopher M. Turoski, Esq.;Cargill, Incorporated, 15407 McGinty Road West, Wayzata, MN, 55391-2399, US

(21) Appl. No.: 11/206,262

(22) Filed: Aug. 16, 2005

Related U.S. Application Data
(60) Provisional application No. 60/601,824, filed on Aug. 16, 2004.
(60) Provisional application No. 60/643,322, filed on Jan. 12, 2005.
(60) Provisional application No. 60/660,603, filed on Mar. 11, 2005.

(51) Int. Cl. B02B 3/12

(52) U.S. Cl. 426/521; 99/532

(57) ABSTRACT

A method and apparatus for tenderizing meat is disclosed. Fluid may be injected into a portion of a carcass coinciding with the cut of meat desired for tenderization. The injection site may be sterilized before or during injection of the fluid. The fluid may be a gas, such as carbon dioxide or nitrogen, or may be a liquid. Multiple injections may be performed spaced slightly apart. The injection apparatus may include a plurality of injectors or needles having openings for gas passage therethrough. The needles may be attached to a base having a hose attached thereto. Fluid may be pumped through the hose, through the base, through the needles, and into the carcass. A sterilization assembly may be provided with the injection apparatus for sterilizing the injection site before and/or during injection.

### FIELD OF THE INVENTION

This invention relates generally to a method and apparatus for tenderizing meat, and more specifically to a method and apparatus for tenderizing meat by injecting a fluid into meat. This application claims priority to U.S. Provisional Application Serial No. 60/601,824, filed Aug. 16, 2004, U.S. Provisional Application Serial No. 60/643,322, filed Jan. 12, 2005, and U.S. Provisional Application Serial No. 60/660,603, filed Mar. 11, 2005, all herein incorporated by reference.

### BRIEF SUMMARY OF THE INVENTION

The present invention provides a method and apparatus for tenderizing meats by injecting a fluid, such as compressed gas, into muscles or muscle groups of a carcass. The method and apparatus may further be used for sterilizing the injection site before and/or during injection. The method and apparatus may be used to tenderize any cuts of meat and is particularly useful in tenderizing cuts of meat that are not typically tender. The method and apparatus may be used, for example, to tenderize a strip loin, lip-on ribeye, top butt, inside round, round flat, eye of round, knuckle, or clod.

An injection apparatus having one or more injectors or needles may be used for meat tenderization. A sterilization assembly may optionally be provided with the injection apparatus for sterilizing the injection site. The injection apparatus may have, for example, between 1 and 5 injectors or needles. Each injector or needle may or may not be perforated. Thus, in one embodiment, the injector or needle may expel fluid only through an opening at a forward end of the needle. In an alternate embodiment, the injector or needle may expel compressed gas through a plurality of openings provided along the needle for gas passage. Each needle has a forward end and a rearward end, the rearward end of each needle being attached to an adaptor. A flexible elongate hollow member or hose is also attached to the adaptor. Gas(es) or liquid may be pumped through the hose, into the base, and through the needles for injection into the meat.

Meat tenderization is achieved by inserting at least one needle into a muscle or muscle group of a carcass and injecting fluid through the at least one needle into the muscle or muscle group of the carcass. The fluid may be a compressed gas comprising a single gas or a mixture of gases.

While multiple embodiments are disclosed, still other embodiments of the invention will become apparent to those skilled in the art from the following detailed description, which shows and describes illustrative embodiments of the invention. As will be realized, the invention is capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

FIG. 1 illustrates a carcass marked with areas representing various cuts of meat.

FIG. 2 illustrates an injection apparatus in accordance with one embodiment of the present invention.

FIG. 3 illustrates an injection needle in accordance with one embodiment of the present invention.

FIG. 4 illustrates an manifold in accordance with one embodiment of the present invention.

FIG. 5a illustrates an injection apparatus and sterilization assembly in accordance with one embodiment of the present invention.

FIG. 5b illustrates an injection apparatus and sterilization assembly in accordance with one embodiment of the present invention.

FIG. 5c illustrates an injection apparatus and sterilization assembly in accordance with one embodiment of the present invention.

FIG. 5d illustrates an injection apparatus and sterilization assembly in accordance with one embodiment of the present invention.

FIG. 5e illustrates an injection apparatus and sterilization assembly in accordance with one embodiment of the present invention.

FIG. 6 illustrates an injection apparatus and sterilization assembly in accordance with one embodiment of the present invention.

FIG. 7 illustrates an injection apparatus and sterilization assembly in accordance with one embodiment of the present invention.

FIG. 8 illustrates a schematic diagram of adjustable pulse modules for regulating the time gas is applied in accordance with one embodiment of the present invention.

FIG. 9 illustrates a control box in accordance with one embodiment of the present invention.

FIG. 10 illustrates a control box in accordance with one embodiment of the present invention.

FIG. 11 illustrates a fluidic logic control schematic for the injection apparatus and sterilization assembly of FIGS. 5b-5f in accordance with one embodiment of the present invention.

FIG. 12 illustrates a component assembly diagram for the injection apparatus and sterilization assembly of FIGS. 5b-5f in accordance with one embodiment of the present invention.

FIG. 13 illustrates an injection apparatus in accordance with one embodiment of the present invention.

FIG. 14 illustrates the injection apparatus of FIG. 13 with a protective covering provided over the injector.

FIG. 15 illustrates the injection apparatus of FIG. 13.

FIG. 16 illustrates the injection apparatus of FIG. 13 prior to insertion into a carcass side.

FIG. 17 illustrates the injection apparatus of FIG. 13 inserted into a carcass side.

FIG. 18 graphically illustrates the percentage of strip loin tender by days of aging for all tested carcasses for one example of a system and method for tenderizing meat.

FIG. 19 graphically illustrates the percentage of top butt tender by days of aging for all tested carcasses for one example of a system and method for tenderizing meat.

FIG. 20 graphically illustrates the percentage of strip loin tender by days of aging for RR ribeye and marbling carcasses for one example of a system and method for tenderizing meat.

FIG. 21 graphically illustrates the percentage of top butt tender by days of aging for RR ribeye and marbling carcasses for one example of a system and method for tenderizing meat.

### DETAILED DESCRIPTION OF THE INVENTION

A method and apparatus for tenderizing meats by injecting fluid such as compressed gas or high pressure liquid into muscles or muscle groups of a carcass is disclosed. The method and apparatus may further be used for sterilizing the injection site. The method and apparatus may be used to tenderize any cuts of meat and are particularly useful in tenderizing cuts of meat that are not typically tender. While the method and apparatus are described with reference to beef steer and heifer carcasses, the meat tenderization system may be used to tenderize meat (for example pork, lamb, veal, cow and bull), poultry (for example turkey and chicken) or fish from any source, including meat removed from a carcass.

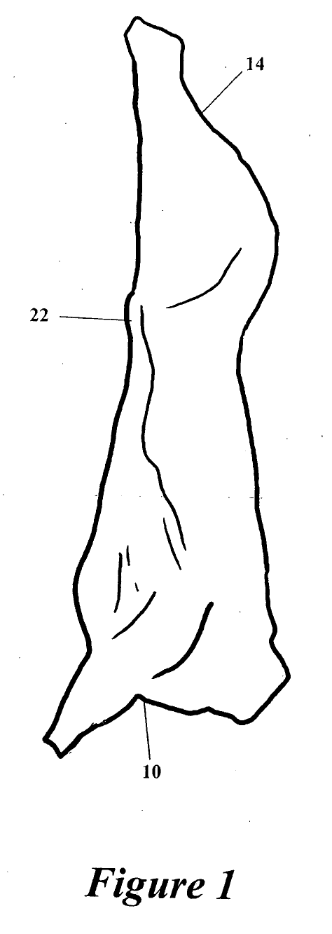

Fluid is injected into muscle or muscle groups of a carcass to improve tenderness. Suitable gases include, for example, air, carbon dioxide (CO₂), nitrogen (N₂), carbon monoxide (CO) or carbon monoxide blends, oxygen (O₂), other suitable gas, or mixtures thereof. In one embodiment, the gas is injected prior to the onset of rigor mortis. Frequently, cattle will be exsanguinated. The onset of rigor occurs within about two hours of exsanguination and is typically fully resolved in about eight hours. Generally, the onset of rigor occurs within forty-five minutes to one hour after exsanguinations (or death of the animal). Thus, in one embodiment, fluid is injected within about forty-eight hours of exsanguination. In another embodiment, the fluid is injected within about twenty-four hours after exsanguination. In yet another embodiment, the fluid is injected within about twelve hours after exsanguination. The gas may be injected into any area of the carcass. Generally, the gas is injected in areas of the carcass coinciding with the cuts of meat desired for meat tenderization using the present invention. FIG. 1 illustrates a beef carcass marked with areas representing various cuts of meat.

Chuck, round, brisket, plate, shank and flank cuts tend to be “tough” or “less tender” cuts of meat. Chuck comes from the shoulder 10 of the animal and includes some of the backbone, rib, blade, and arm bones. This is a heavily exercised part of the animal; the meat tends to be tough, and contains a good deal of connective tissue. Retail chuck cuts include chuck eye roast, top blade steak, arm pot roast, shoulder pot roast, cross-rib roast, chuck steak, stew meat and ground chuck. The round 12 is a large cut that encompasses the entire rear leg of the animal and includes the shank and tailbone. Cuts from the round are quite lean and include round steak, eye of round, top round, and round tip, as well as rump roast and Pikes Peak roast. The brisket and shank lie beneath the primal chuck and encompass the breast and foreleg of the animal. The brisket is tough and fatty. Brisket and shank cuts include whole brisket, flat cut brisket, corned beef, and shank cross cut. Located in the rear underbelly of the carcass, the flank produces flavorful albeit tough meat that contains connective tissue. Its boneless cut is known as flank steak. The short plate, located on the underside of the rib cage, produces meat that tends to be tough and fatty. Cuts include skirt steak and short ribs.

Other areas of the carcass that may be tenderized by fluid injection include the rib section, the short loin, and the sirloin. The cuts of meat produced from these areas tend to be relatively tender. The rib section, located just behind the shoulder or chuck tends to be relatively tender and well-marbled. The rib section produces rib roast, rib-eye roast, rib steaks, rib-eye steaks, and back ribs. The short loin 22, located just behind the ribs, produces the most tender cuts of beef. These cuts include top loin and tenderloin steaks, filet mignon, T-bone steak, Porterhouse steak, top loin roast and tenderloin roast. The sirloin comes from the mid part of the hindquarters and contains parts of both the backbone and the hip bone. Sirloin cuts are tender, and lean. Cuts from the sirloin include tri-tip roast, and bone-in or boneless top sirloin steaks.

Thus, injection of fluid, for example compressed gas, into the carcass provides tenderized meat, for example meat that is not typically tender such as chuck, round, brisket, shank, short plate meats, and end or thin meat portions. Injection of fluid tenderizes meats such as sirloin, loin or rib subprimals. Further, injection of fluid may be used to tenderize meats such as strip loin, lip-on ribeye, top butt, inside round, round flat, eye of round, knuckle and clod. Improved tenderization is thus achieved without adding tenderizing injections (other than gas), infusions, marinades, etc. Further, injection of gas into the carcass to provide tenderized meat may be done in lieu of mechanical tenderization.

The fluid is injected into the carcass muscles or muscle groups to improve tenderness, not specifically to separate muscles from bones. According to one embodiment, the fluid injection does not substantially separate meat from bone. The injection site is sterilized before or during injection of the fluid to minimize the possibility of any surface contaminants traveling into the muscle via needle insertion.

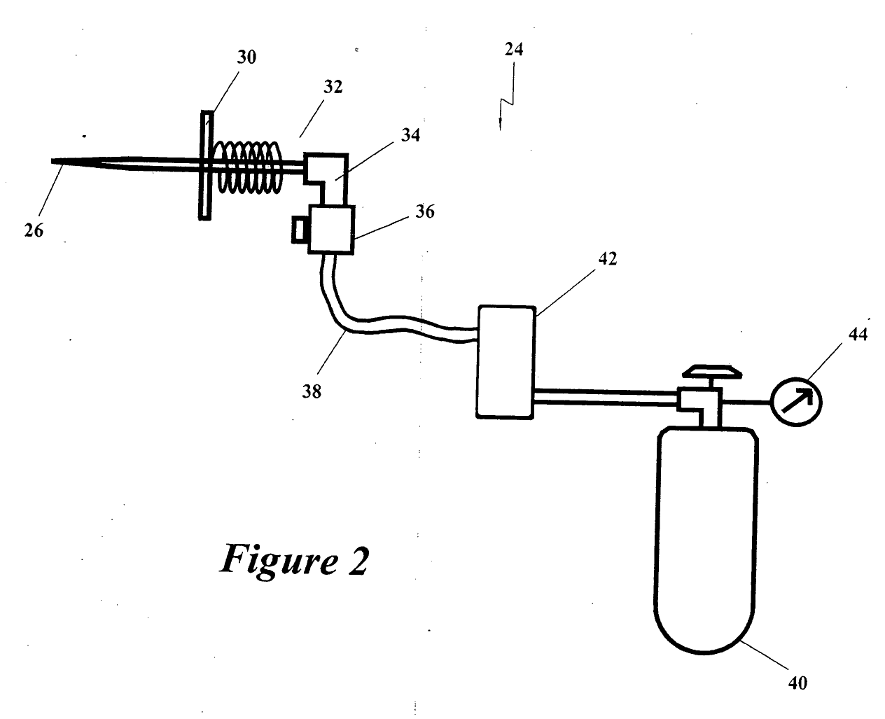

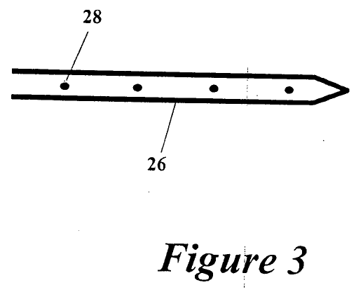

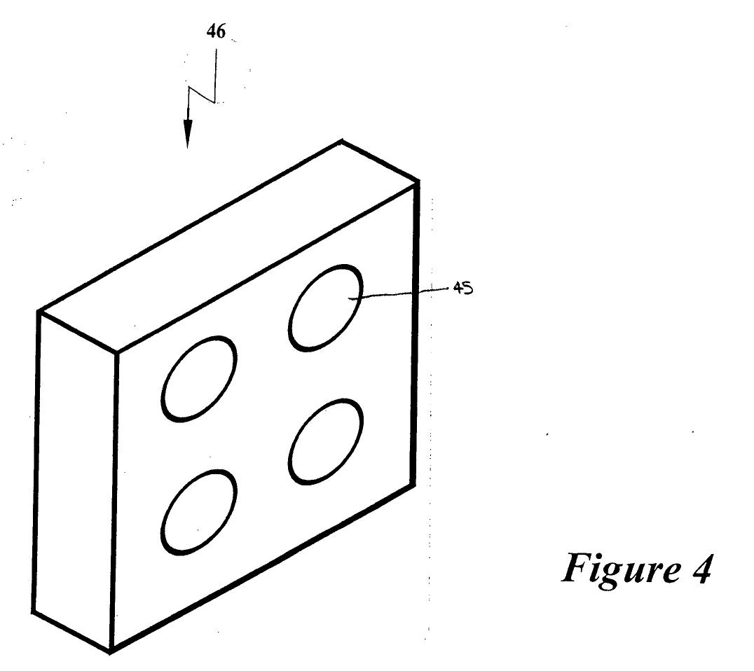

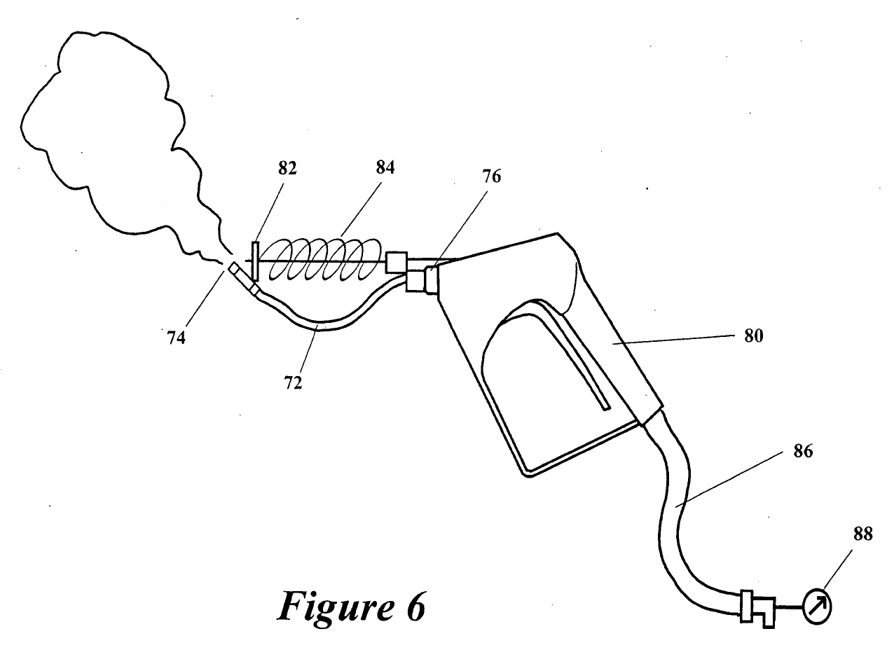

FIG. 2 illustrates one embodiment of an injection apparatus 24 for injecting compressed gas into a carcass. A sterilization assembly may be optionally be provided with the injection apparatus for sterilizing the injection site before and/or during injection as described in more detail below. In the embodiment of FIG. 2, a single needle or injector 26 is provided. In alternate embodiments, a plurality of needles or injectors may be provided. Generally, the injector is a hollow elongate member. Any suitable configuration of injector may thus be used. The injector (or needle) 26 comprises a forward end and a rearward end. In the embodiment shown, the length of the needle 26 between the forward end and the rearward end is approximately 4.5 inches. The needle is of relatively small diameter with the forward end being sufficiently sharp to allow insertion into the meat without damaging the meat. The needle 26 includes a plurality of openings 28 (seen in FIG. 3) along the length of the needle 26 for gas passage. For example, sixteen openings 28 may be provided. The needle 26 extends through a squash plate 30, a compression spring 32 being provided on one side of the squash plate 30 towards the rearward end of the needle 26. The squash plate 30 and compression spring 32 may be manufactured of any suitable material. In one embodiment, the squash plate 30 and compression spring 32 are manufactured of stainless steel. At its rearward end, the needle 26 is coupled to an adaptor 34. The needle 26 may be coupled to the adaptor 34, for example, via pressure fitting the needle 26 into a receptor of the adaptor 34, as described in relation to FIG. 4. The adaptor 34 includes a passage therein for gas passage to the needle 26. The adaptor 34 may be, for example, a ⅛″×¼″ adaptor. The adaptor 34, in turn, is coupled to a button valve 36 for controlling gas release from the injection apparatus 24. Alternately, or additionally, the adaptor 34 may be coupled to a relax action gun, as shown in FIG. 6.

A hose 38 is provided extending between the button valve 36 and a gas tank 40 such that gas may be pumped through the hose 38, through the valve 36, through the adaptor 34 and into the needle 26. The gas passes through the openings 28 in the needle for gas passage in the needle 26 and into the meat. The gas tank 40 may contain, for example, carbon dioxide (CO2) or nitrogen (N2) gas. A timer or filter 42 may be provided intermediate the button valve 36 and the gas tank 40. The gas tank 40 is provided with a regulator 44 for monitoring pressure. In one embodiment, the pressure of the tank 40 ranges from 25 to 75 PSI.

Any suitable manner of coupling the tank 40 to the injection apparatus 24 may be used so long as it enables gas passage from the tank to the injection apparatus 24 for explusion through an injector 26 into the meet.

FIG. 3 illustrates a needle or injector 26 suitable for use with an injection apparatus as described above. In the embodiment of FIG. 3, the length of the needle 26 between the forward end and the rearward end is four inches. Sixteen openings 28 for gas passage are provided along the length and around the circumference of the needle 26. In one embodiment, the needle 26 is approximately 0.128″ in diameter and each opening is approximately 0.036″ in diameter. In accordance with the method of tenderizing meat, compressed gas at less than 40 PSI may be pushed through the needle 26 for approximately 5 seconds. In alternate embodiments, the gas may be provided at differing pressures, for example between 10 and 75 PSI and for differing amounts of time.

In some situations, it may be desirable to provide a plurality of needles, for example four needles, on the injection apparatus. FIG. 4 illustrates a manifold 46 for receiving a plurality of needles. The manifold may comprise a relatively stiff elastomer and includes a passage therein for gas passage. By manufacturing the manifold of an elastomer, flexibility is imparted to the needles and each needle is allowed to move somewhat independently of the other needles. Thus easier insertion and retraction of the needles is enabled. As shown, four receptors 45 are provided for receiving a needle or injector. The rearward end of each needle to be used is pressed into the receptor 45 until a pressure fit is attained. The needles are releasably coupled to the manifold 46 such that if a needle is damaged, it may be released from the adaptor and a replacement coupled in its place rather than requiring replacement of the entire injection apparatus. In the embodiment shown, four needles may be coupled to the manifold 46, one needle towards each corner of the adaptor. Differing spacings or configurations may be used according to alternate embodiments. Further, it is not necessary to use exactly four needles, more or fewer may be provided as desired. The manifold 46 may be provided on a relax action gun such as that shown in FIG. 6.

As discussed above, the injection apparatus may optionally be supplemented with a sterilization assembly. The sterilization assembly may be used to kill microbes or other contaminants on the surface and/or to sterilize the needle(s) of the injection apparatus. Thus, the risk of dragging contaminants from the surface into the meat is minimized or eliminated. Several embodiments of sterilization assemblies are herein disclosed. Any of these, or other, sterilization assemblies may be used with an injection apparatus to sterilize the injection site and/or the needle before or during the injection of fluid into the muscle.

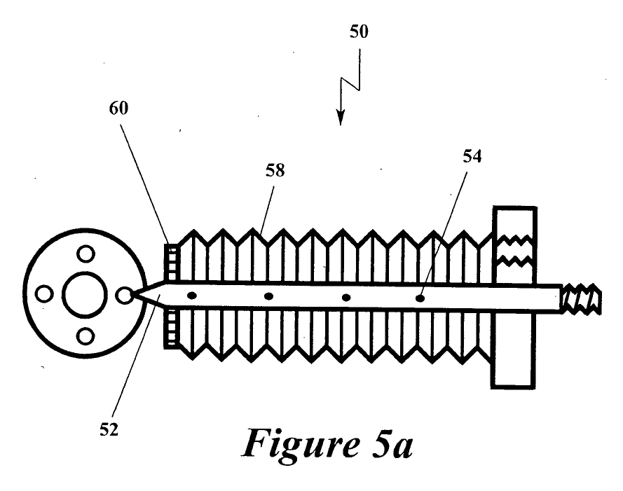

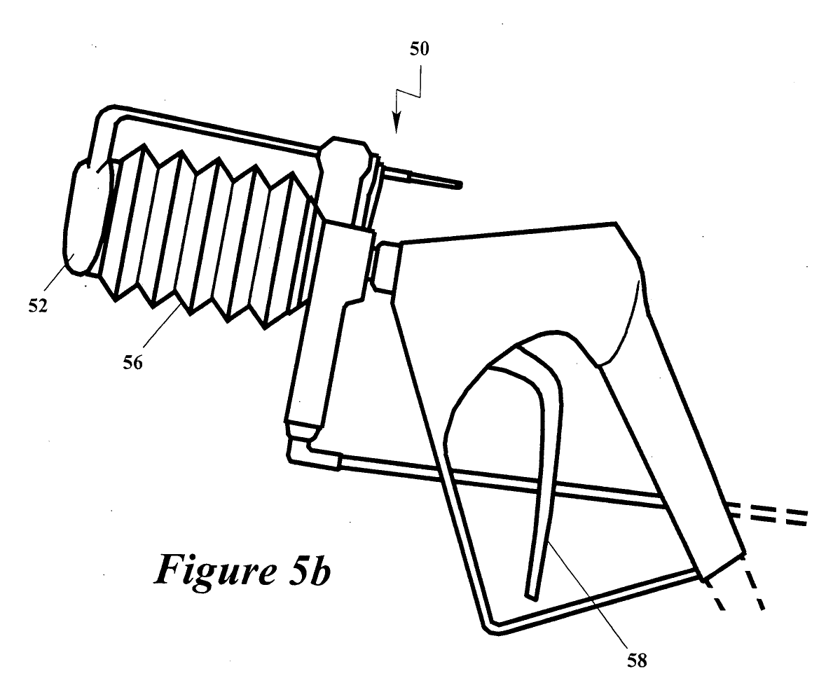

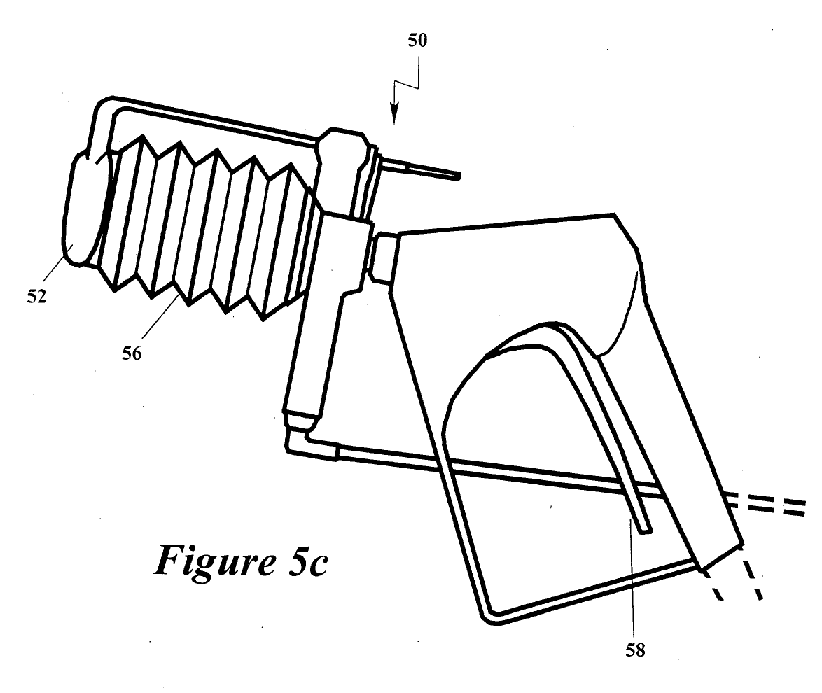

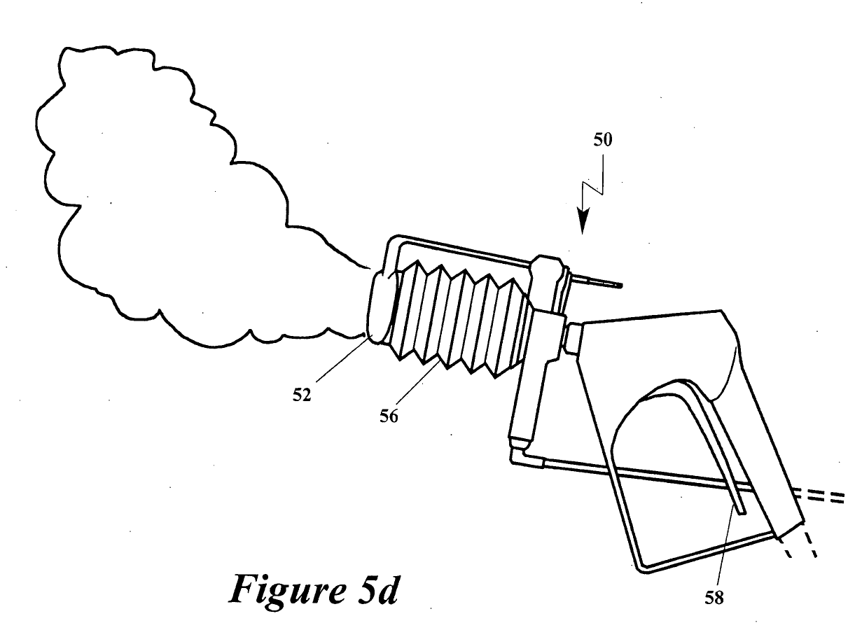

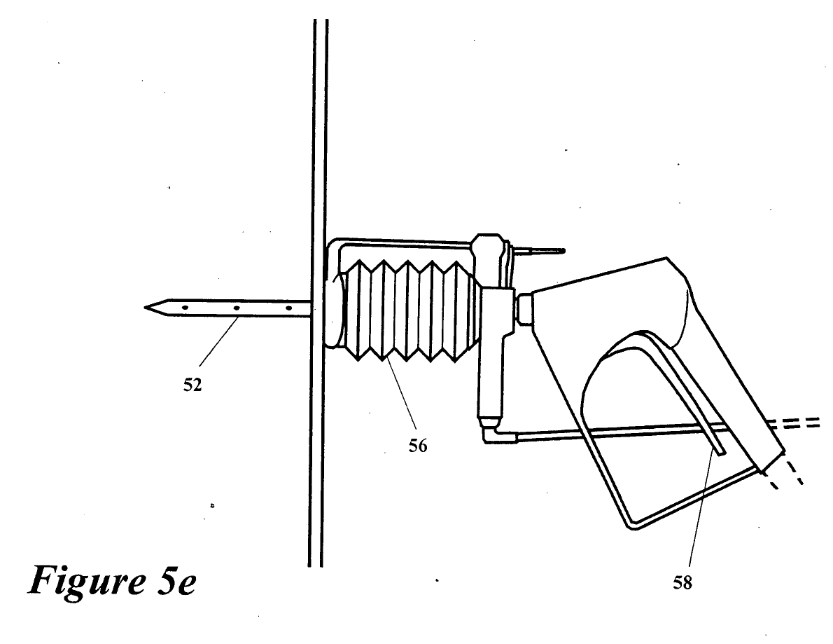

FIG. 5a illustrates an injection apparatus and sterilization assembly 50 in accordance with one embodiment of the present invention. The injection apparatus comprises a single needle 52 having a plurality of openings 54 for gas passage, the needle 52 being surrounded by a retractable bellows assembly 56 for expelling steam. The needle 52 comprises a forward end and a rearward end. The forward end of the needle 52 is sufficiently sharp to allow insertion into the meat without damaging the meat. The rearward end of the needle 52 is coupled to an assembly such as shown in FIG. 2 for passage of gas from a gas tank through the needle. Alternately, or additionally, the rearward end of the needle may be coupled to a relax action gun, shown in FIG. 6.

A bellows assembly 56 is provided surrounding the needle 52 intermediate the forward end and the rearward end. A suitable bellows assembly is a stainless steel bellows by Sigma-Netics B38 x 26, 5-8-8.5. The extended length of the bellows may be approximately 3.75″ to 4″. The compressed length of the bellows may be approximately 20 mm. In one embodiment 8 corrugations are provided per 26 mm of length. Thus, approximately 32 corrugations may be provided. FIGS. 5a-5d are intended to be illustrative of the bellows assembly only and varied numbers of corrugations may be provided in the bellows assembly. The bellows assembly 56 includes a low pressure steam supply inlet at or near the rearward end of the needle. In one embodiment, steam at 10 psig and 239° F. is supplied to the bellows assembly 56 through the inlet. A plate 58 is provided at or near the forward end of the needle for receiving a forward end of the bellows assembly 56. The plate 58 thus caps the forward end of the bellows assembly 56. The plate 58 includes at least one hole for expelling steam therethrough. Steam may thus be supplied through the bellows assembly 56 to the injection site, thereby sanitizing the injection site.

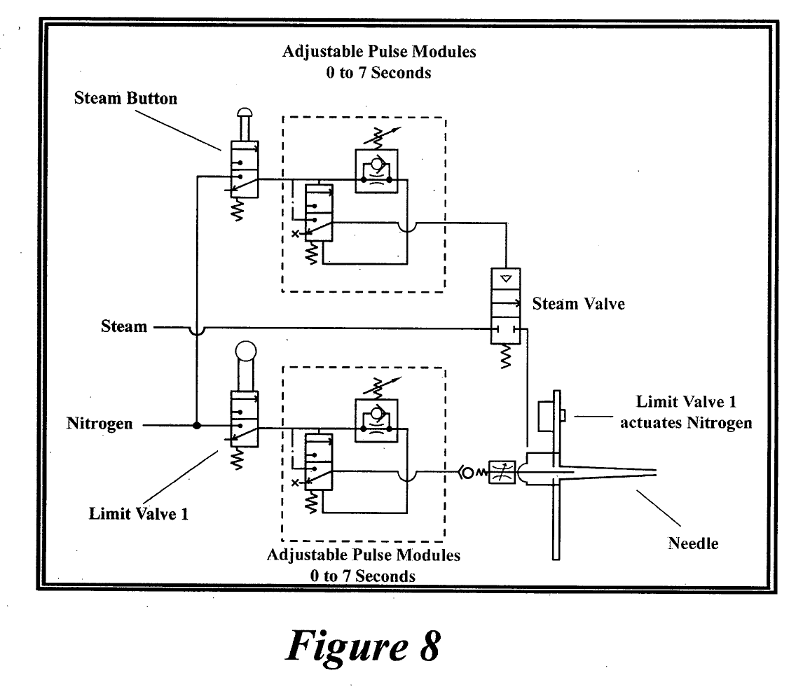

In use, the assembly of FIG. 5a is activated to expel steam 57 (see FIG. 5d) as the needle 52 approaches the carcass. The steam 57 sanitizes the surfaces of the carcass and sanitizes the needle 52. The needle 52 is inserted into the meat. During insertion, the assembly 50 may continue expelling steam. As the needle 52 is inserted, the bellows assembly 56 is compressed. At a certain depth, gas injection may be triggered either manually or automatically. FIG. 8 illustrates the valve actuation and time-adjustable gas pulse modules of the needle. A suitable range for the adjustable pulse modules for applying gas may be 0 to 7 seconds. After injecting gas into the meat, the needle is withdrawn and the bellows assembly re-extends.

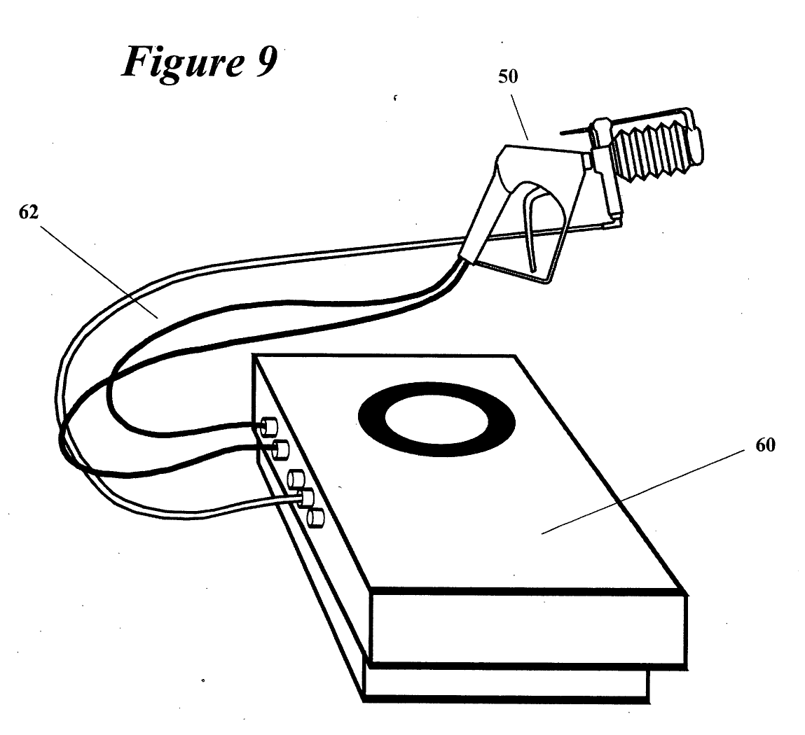

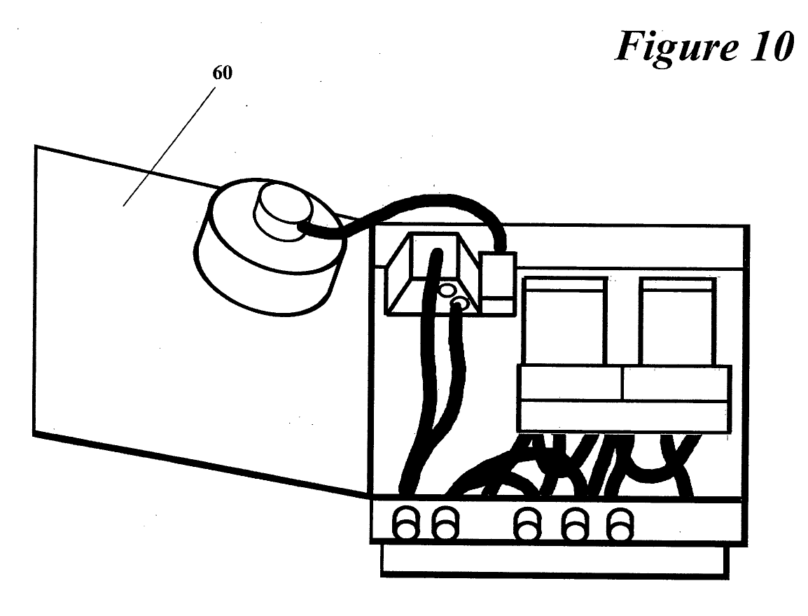

FIGS. 5b-5e illustrate alternate views of an injection apparatus and sterilization assembly 50, the injection apparatus comprising a single needle 52 having a plurality of openings 54 for gas passage with the needle 52 being surrounded by a retractable bellows 56 assembly for expelling steam 57. FIG. 5b illustrates a perspective view of the injection apparatus and sterilization assembly 50. FIG. 5c compression of a trigger 58 to allow steam to throw through the injection apparatus. FIG. 5d illustrates the expulsion of steam 57 from the injection apparatus and sterilization assembly 50 through the bellows assembly 56. The injection apparatus is positioned near the surface to be penetrated by the needle 52. Expelled stream 57 sterilizes the area around the penetration site. FIG. 5e illustrates the needle 52 inserted through the surface. For the purposes of illustration, the needle is inserted through a planar surface 59. In use, however, the needle 52 is inserted into, for example, muscle. The needle 52 is sterilized by heat from steam surrounding it in the bellows assembly 56. Once the needle 52 is fully inserted, a micro-switch or switch valve may be activated to activate a pilot on the control box (see FIGS. 9 and 10), thereby triggering the compressed gas or fluid cycle to start.

In one embodiment, the injection apparatus and sterilization assembly of FIGS. 5b-5e is configured as follows. The injection apparatus comprises a handle assembly, or gun handle, needle mount and needle. A suitable gun handle is a Suttner America Model ST 2700 stainless steel. The needle mount may be machined to screw onto the gun handle with porting for compressed air supply to the needle and steam to a bellows chamber. A suitable needle is a Hantover Type “H” Spray needle 0.187Δ OD with 16 holes. The sterilization assembly comprises a bellows, steam containment chamber provided surrounding the needle. A compression spring is provided wherein the normal position of the spring maintains the extended steam chamber bellows in position to cover the needle. A limit valve compressed gas activation switch, for example as available from Clippard, and a compressed gas check valve are provided for controlling the compressed gas or other fluid. The compressed gas check valve may be a ⅛″ SS 3.6 cracking pressure valve such as Legris 4896-11-11. The configuration of the injection apparatus and sterilization assembly may vary and the embodiment described is meant for illustrative purposes only.

FIG. 9 illustrates a control box 60 with the injection apparatus and sterilization assembly 50 of FIGS. 5b-5e coupled thereto. FIG. 9 illustrates the exterior of the control box 60. FIG. 10 illustrates the interior of the control box 60. In one embodiment, the control box assembly comprises a NEMA 4x enclosure, an adjustable pulse module 0-7 seconds (Clippard R-101), a sub-plate (Clippard R-101), a mounting rail (Clippard R-102-1) and stand offs (Clippard R-107-20). For controlling the compressed gas or other fluid, the control box includes a compressed gas regulator (Watts R384-D1-C), a compressed gas regulator panel nut (Watts R05X5 1-P), a compressed gas pressure gage (Marsh J6352, 2.5Δ 0-160 psi) and a vent (Alwitco B280154028). The control box further comprises FDA 1/4″ SS bulkhead fittings (Legris 3616-56-00), FDA ¼″ tube to ¼″ NPT 90 (Legris 3109-56-14), FDA ¼′ tube to ¼″ tube Tee (Legris 3604-56-00) and ¼″ polyurethane tubing (Clippard 3814-6-BK). The configuration of the control box may vary and the embodiment described is meant for illustrative purposes only.

Suitable hose assemblies 62 for the injection apparatus and sterilization assembly 50 of FIGS. 5b-5e and control box 60 of FIGS. 9 and 10 include, for example, a compressed gas supply ¼″ polyethylene tubing bend radius 0.75″ (Nycoil 62440), compressed gas control ¼″ polyurethane tubing (Clippard 3814-6-BK), steam supply ¼″ ID SS braided hose with male SS ¼″ NPT fittings both ends; swivel one end, a steam regulator ½″ 10-5 psi including screen (Watts 0830910) and a compressed gas filter auto drain (Watts F602-02-WGR). The configuration of the hose assemblies may vary and the embodiment described is meant for illustrative purposes only.

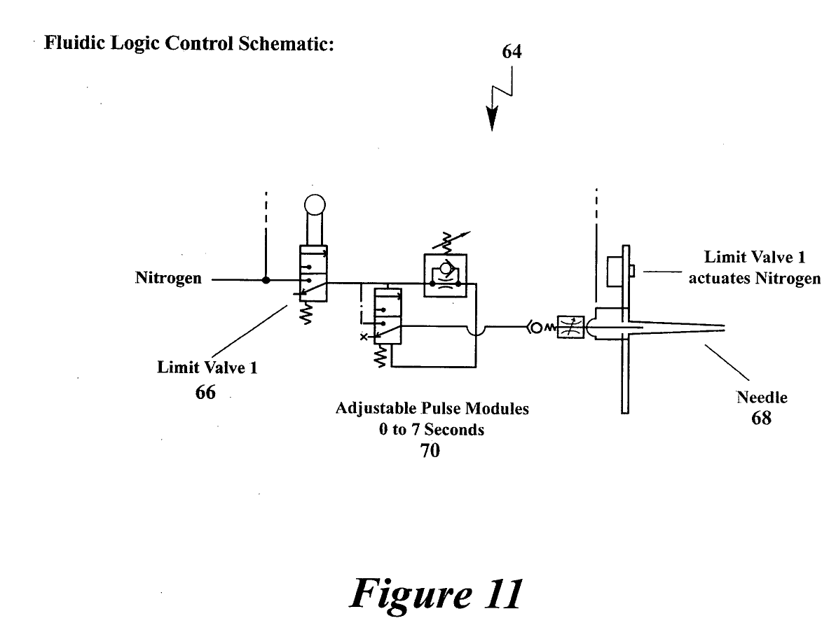

FIG. 11 illustrates a fluidic logic control schematic 64 for the injection apparatus and sterilization assembly 50 of FIGS. 5b-5e. As shown and discussed above, a limit valve 66 is provided to actuate release of the compressed gas or other fluid. FIG. 11 illustrates the limit valve 66 proximate the needle 68. In such embodiment, the valve 66 may be automatically actuated when the needle 68 reaches a set depth. However, the limit valve 66 may be otherwise provided and may be configured for manual actuation. Pulse modules 70, for example adjustable pulse modules 0-7 seconds, is provided. Gas release is triggered via the pulse modules 70.

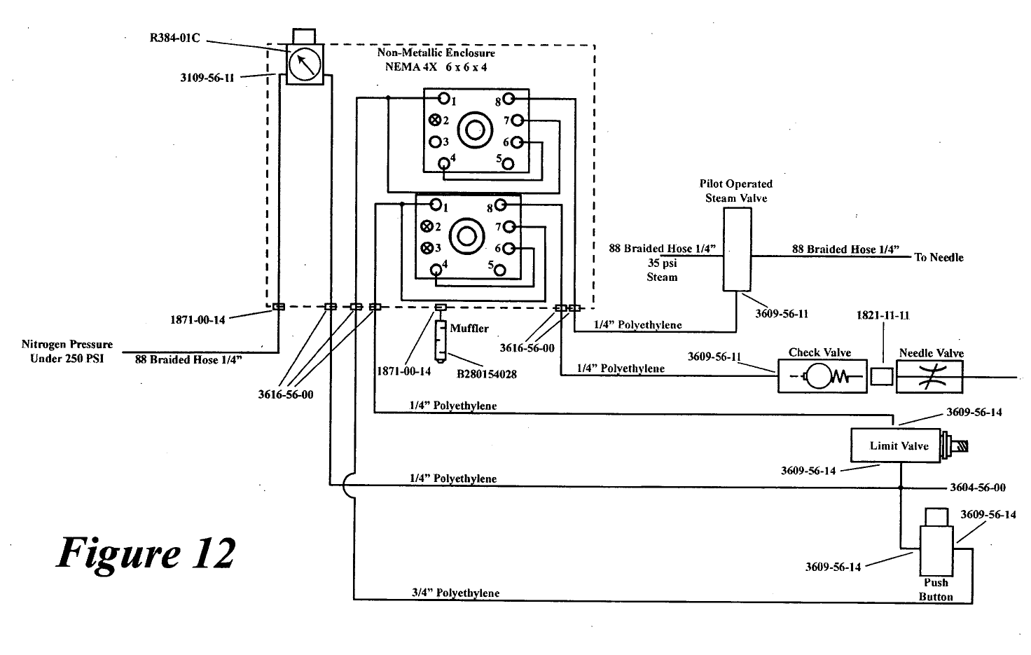

FIG. 12 illustrates a component assembly diagram for the injection apparatus and sterilization assembly of FIGS. 5b-5f.

FIG. 6 illustrates a sterilization assembly in accordance with one embodiment of the present invention. The sterilization assembly is shown with the injection apparatus 24 of FIG. 2. A hose 72 having a nozzle 74 at a forward end thereof and being coupled to an adaptor 76 at a rearward end thereof is provided for expelling steam. Generally, sterilization steam 78 is expelled from the nozzle at 239° F. The adaptor 76 is coupled to a relax action gun 80. In one embodiment, the hose 72 is a ⅜″ hose and the adaptor 76 is a ¼″ NPT adaptor. Intermediate the forward end and rearward end of the hose 72, the hose is coupled to a squash plate 82. The squash plate 82 may have a needle extending therethrough as described in relation to FIG. 2. A support rod, coupled to a set collar, may be provided for supporting the injection apparatus on the relax action gun. A suitable relax action gun 80 for use with the sterilization assembly is the Suttner RT 2700 Stainless Steel 12 gpn/4500 PSI relax action gun. A second hose 86 is provided extending from the relax action gun 80 to a steam supply (not shown). In one embodiment, the second hose is a ⅜″ hose. A steam regulator 88 may be provided intermediate the relax action gun 80 and the steam supply for regulating the steam. Thus, for example, the steam may be regulated to a maximum of 10 psig.

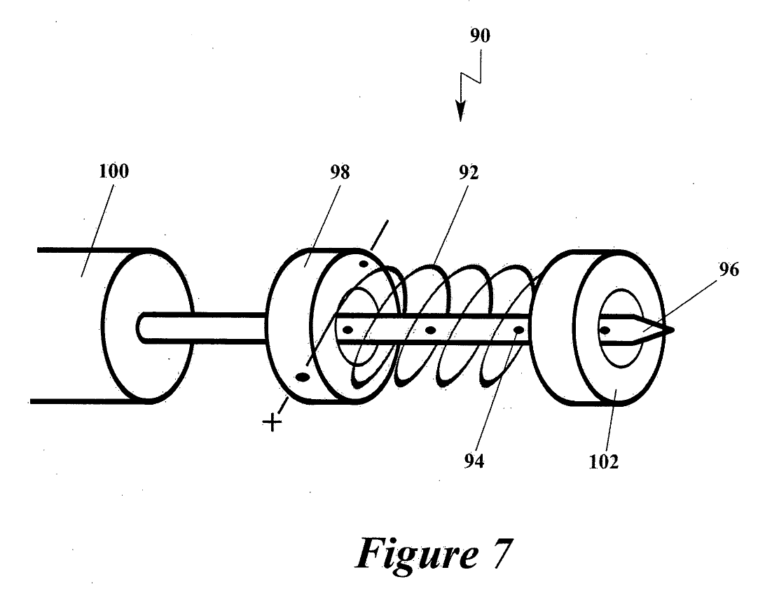

FIG. 7 illustrates an injection apparatus and sterilization assembly 90 in accordance with one embodiment of the present invention. The injection assembly comprises a single needle 92 having a plurality of openings 94 for gas passage and a cauterizing tip 96. The needle 92 has a forward end and a rearward end. The forward end is sufficiently sharp to allow insertion into the meat without damaging the meat. The rearward end of the needle 92 extends through a mounting base 98 to a hose 100 with a fitting for receiving the rearward end of the needle 92. The mounting base 98 may be manufactured of any suitable material. In one embodiment, the mounting base 98 is manufactured of stainless steel. The mounting base 98 includes a positive terminal and a negative terminal. A corresponding mounting plate 102 is provided near the forward end of the needle 92. A spring mount and current conductor 104 extends between the first and second mounting plates 98, 102. In one embodiment, the spring mount and current conductor 104 is stainless steel. The tip of the needle 92 is thus able to be heated to a temperature of more than 180° F. Thus, a cauterizing tip 96 is provided. Touching the meat with the cauterizing tip 96 thus sterilizes the area before the needle is inserted into the meat. The needle 92 may be additionally sterilized if desired.

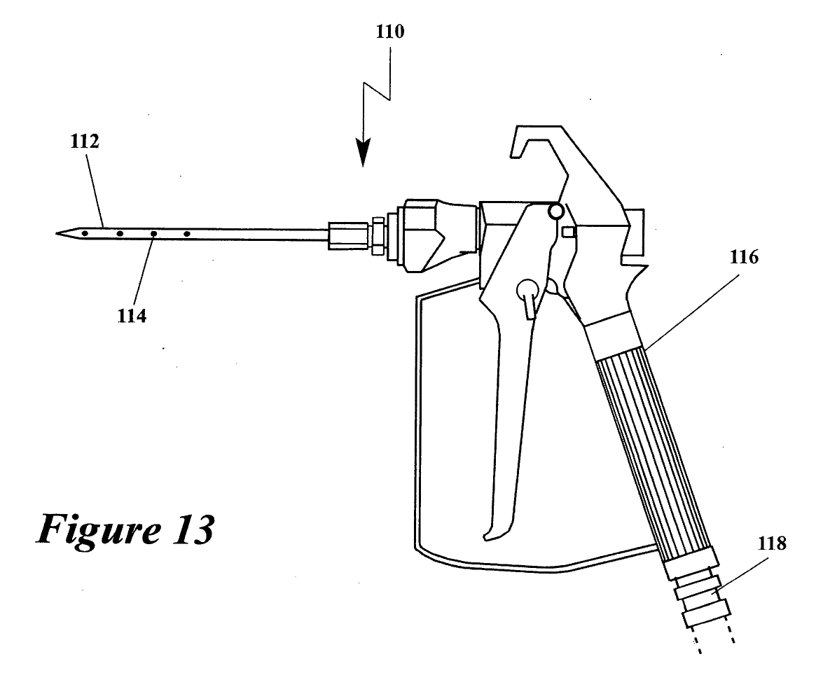

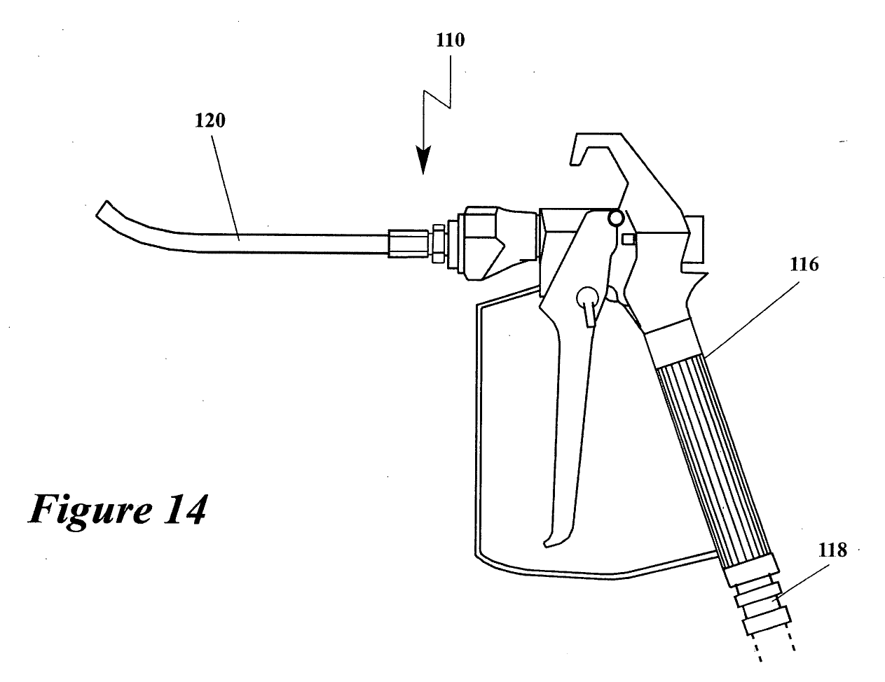

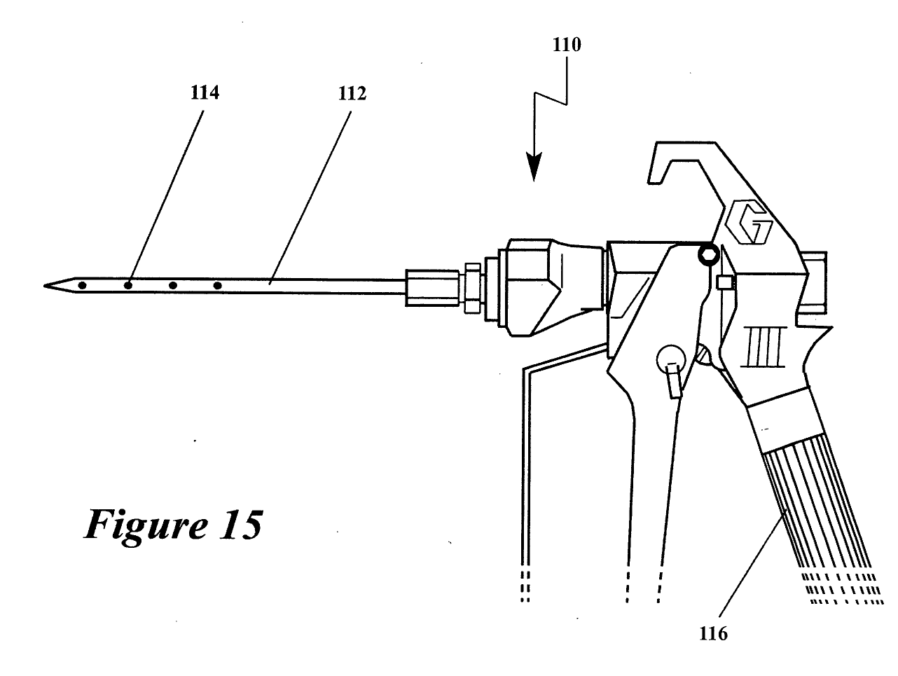

FIGS. 13-15 illustrate a further embodiment of an injection apparatus 110 for injecting compressed gas into a carcass. A sterilization assembly may be optionally be provided with the injection apparatus for sterilizing the injection site before and/or during injection. In the embodiment of FIGS. 13-15, a single needle or injector 112 is provided. In alternate embodiments, a plurality of needles or injectors may be provided. The needle 112 comprises a forward end and a rearward end. The needle 112 is of relatively small diameter with the forward end being sufficiently sharp to allow insertion into the meat without damaging the meat. The needle 112 includes a plurality of openings 114 (see, for example, FIG. 15) along the length of a forward portion of the needle for gas passage. The needle 112 is coupled to a relax action gun 116. The relax action gun 116, in turn, is coupled to a coupling 118 which may be used to couple the relax action gun 116 to a hose extending to a fluid source. A passageway is provided through the relax action gun 116 to the needle 112 to allow passage of the fluid from the fluid source, through the hose, through the coupling 118, through the relax action gun 116, through the needle 112, and into the meat. FIG. 14 illustrates a protective cover 120 for protecting the injector 112 when the injection apparatus 110 is not in use.

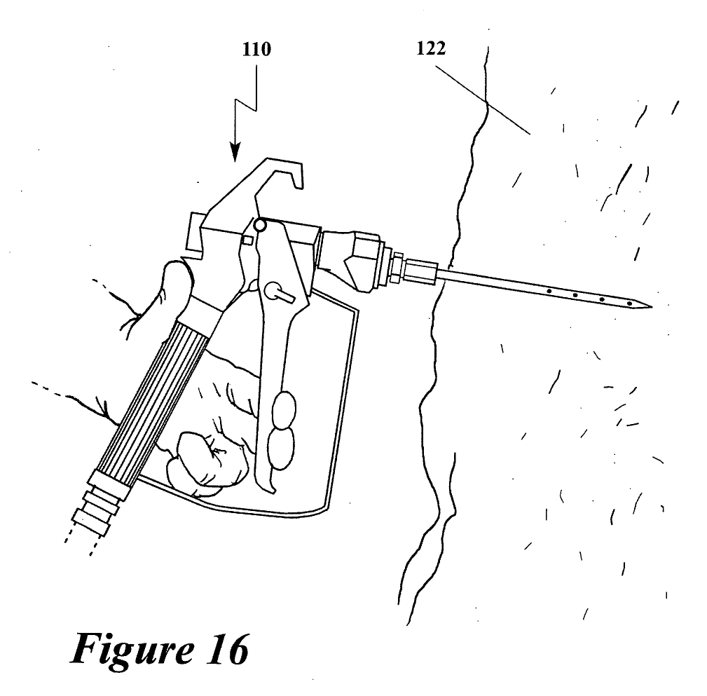

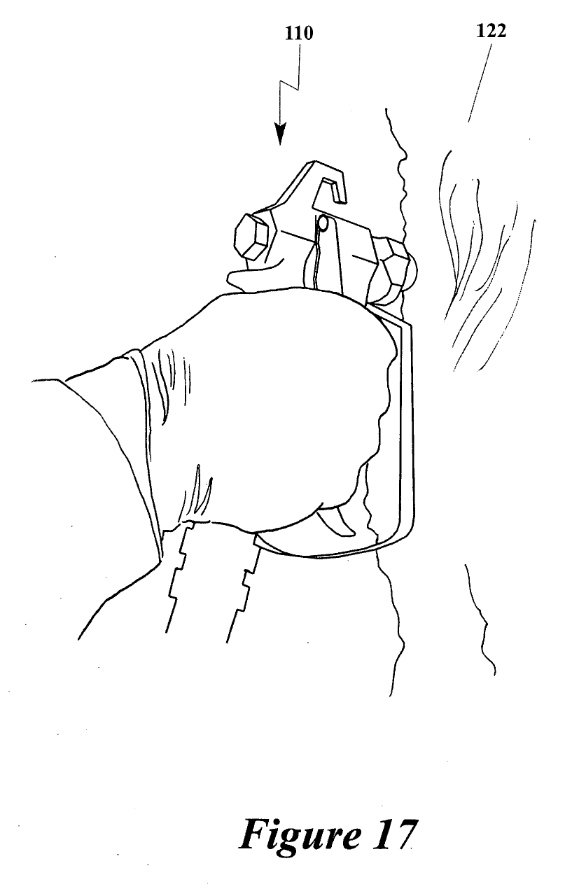

FIG. 16 illustrates the injection apparatus 110 of FIGS. 13-15 pressed against a carcass 122 prior to insertion into the carcass. FIG. 17 illustrates the injection apparatus 110 inserted into the carcass 122.

Using any of embodiments described above, the needles of the injection apparatus are inserted into the meat. Particularly with the embodiments of FIGS. 5a-5e and 6, the meat and needle are sterilized by the sterilization assembly before and during needle insertion. The insertion may be at a particular location and angle as desired depending on the cut of meat to be tenderized. For example, in the middle meat region, the needle may be inserted dorsal to ventral through the geometric center of the muscle or muscle group. Thus, needle insertion for middle meats may originate with the longitudinal orientation of the longissimus muscle near the cartilaginous tips of the superior (rib) and dorsal (loin) spinous processes to penetrate the longissimus muscle at a 45° angle (dorsal to ventral) in both the strip loin and ribeye subprimals. In the hind and forelimb area, thus the round and chuck meat regions, the needle may be inserted perpendicular to the exposed muscle or muscle group. In the top butt and end cuts, needle insertions may originate in the center of each muscle. The needles generally should not be inserted so deeply into the meat as to allow fluid passage outside the muscle or muscle group. The needles of the injection apparatus need not be inserted to their full depth. The injection is typically done at a pressure of between 10 and 100 psi. In one embodiment, the injection is done at 25-75 psi. In one embodiment, the injection is done at 40-50 psi. Generally, the fluid is injected for approximately 0.5 to 5 seconds per injection site.

One to three, for example, injections may be performed at locations corresponding with each cut of meat or each muscle group. If more than one injection is performed, the injections may be spaced from one another, for example, at approximately 3 inches apart. During injection, swelling may be observed in the muscle. When the muscles begins to swell, the injection apparatus is removed and may be reinserted for a subsequent injection.

Using an injection apparatus and sterilization assembly, an operator triggers the sterilization assembly, for example triggering expulsion of steam. The operator directs the injection apparatus and sterilization assembly towards the meat. During sterilization, the operator inserts the needle into the meat. Using pulse modules as shown in FIG. 8, gas release may be automatically triggered upon the needle reaching a set depth. The gas released may be a preset amount for a preset period of time. After insertion of the gas, the operator removes the needle from the meat. If a device such as that shown in FIGS. 5a-5f is used, the bellows assembly expands over the needle as the needle is retracted.

Example of results using a method and apparatus for meat tenderizing are discussed below. The examples are intended to be illustrative of results and are not intended to be limiting.

### EXAMPLE 1

One side of thirty steer carcasses was injected two times at a single location in the center of the strip loin muscle. The side injected was alternated between carcasses. The injection comprised 25 PSI nitrogen gas using a four needle perforated apparatus. The injection was performed pre-rigor, approximately 40 minutes postmortem. The sides opposite the injected sides served as controls. Three boneless strip loin steaks were removed from each side at approximately forty hours postmortem for Slice Shear Force (SSF) tenderness determination. SSF tenderness determination was done after two days of aging, after seven days of aging, and after fourteen days of aging.

TABLE 1
Boneless Top Loin Tenderness

| | | | |
|---|---|---|---|
| Aging Period, d | Control | 25 PSI Nitrogen | Difference |

Slice Shear Force (SSF), kg

| | | | |
|---|---|---|---|
| 2 | 25.3 | 19.7 | 5.6* |
| 7 | 16.3 | 14.1 | 2.2 |
| 14 | 15.9 | 14.0 | 1.9 |

% Tender (SSF > 21.3 kg)

| | | | |
|---|---|---|---|
| 2 | 26.7 | 76.7 | −50.0 |
| 7 | 93.2 | 96.7 | −3.4 |
| 14 | 90.0 | 96.7 | −6.7 |

*P < 0.05

### EXAMPLE 2

One side of twenty-five steer carcasses was injected two times at a single location in the center of the strip loin muscle. The side injected was alternated between carcasses. The injection comprised air gas using a four needle perforated apparatus. The injection was performed pre-rigor, approximately 40 minutes postmortem. The sides opposite the injected sides served as controls. Strip loin steaks and top butt steaks were removed from each side at approximately forty hours postmortem for Slice Shear Force (SSF) tenderness determination. SSF tenderness determination was done after two days of aging, after seven days of aging, after fourteen days of aging, and after twenty-one days of aging. Results were tabulated for all carcasses and for RR ribeye and marbling carcasses only.

TABLE 2
Strip Loin Slice Shear Force, all carcasses

| Aging, d | Control | Air | Difference |
|---|---|---|---|
| 2 | 25.67 | 24.36 | −1.31 |
| 7 | 21.16 | 19.42 | −1.74 |
| 14 | 18.53 | 15.82 | −2.71* |
| 21 | 15.91 | 16.03 | 0.12 |

*P < 0.06

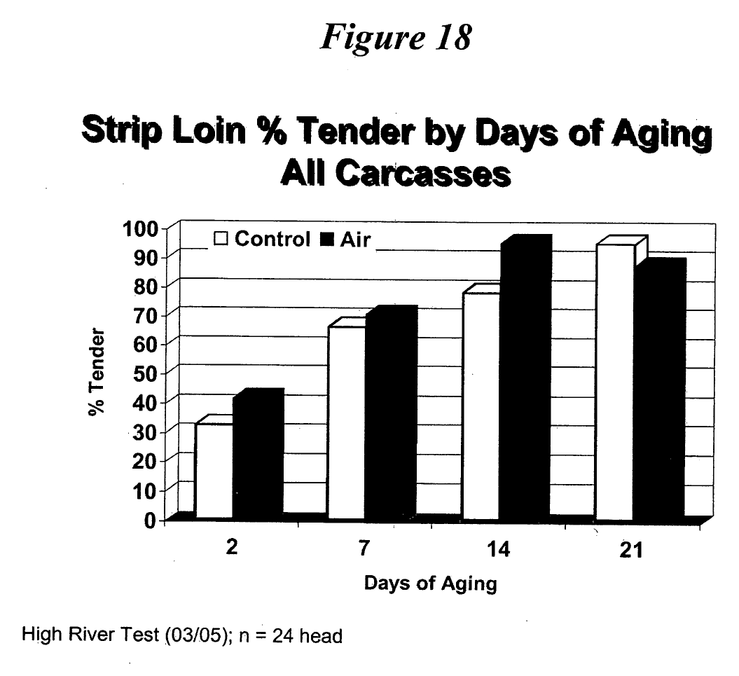

FIG. 18 graphically illustrates the results of Table 2. More specifically, Figure ______ graphically shows the percentage of strip loin tender by days of aging for all carcasses with the results shown for the control carcasses versus the air treated carcasses. Twenty-four carcasses were evaluated.

TABLE 3
Top Butt Slice Shear Force, all carcasses

| Aging, d | Control | Air | Difference |
|---|---|---|---|
| 7 | 23.29 | 22.13 | −1.16 |
| 14 | 18.99 | 18.73 | −0.26 |
| 21 | 17.54 | 16.38 | −1.16 |

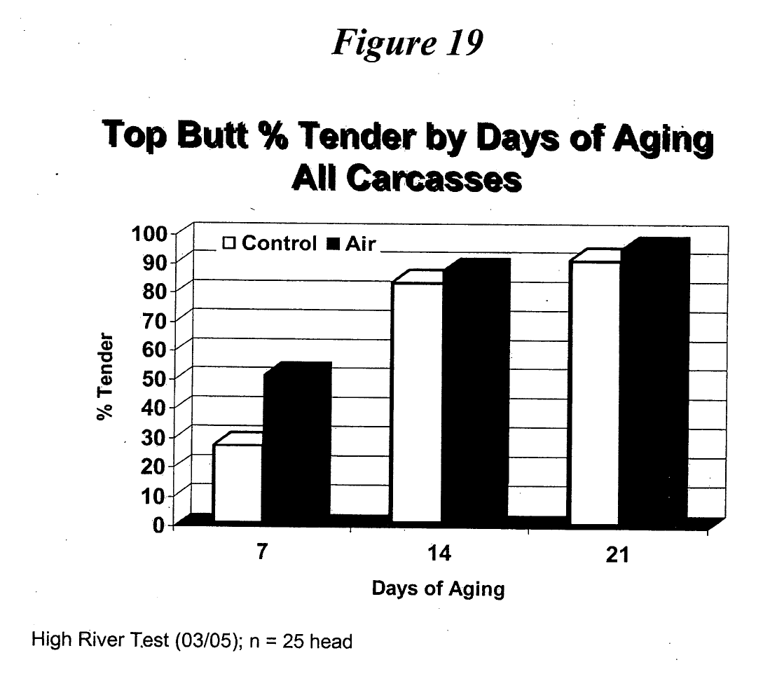

FIG. 19 graphically illustrates the results of Table 3. More specifically, Figure ______ graphically shows the percentage of top butt tender by days of aging for all carcasses with the results shown for the control carcasses versus the air treated carcasses. Twenty-five carcasses were evaluated.

TABLE 4
Strip Loin Slice Shear Force, RR
Ribeye and Marbling Specs Only

| Aging, d | Control | Air | Difference |
|---|---|---|---|
| 2 | 24.99 | 23.80 | −1.19 |
| 7 | 20.90 | 18.66 | −2.24 |
| 14 | 17.73 | 15.06 | −2.67* |
| 21 | 15.88 | 15.04 | −0.84 |

*P < 0.07

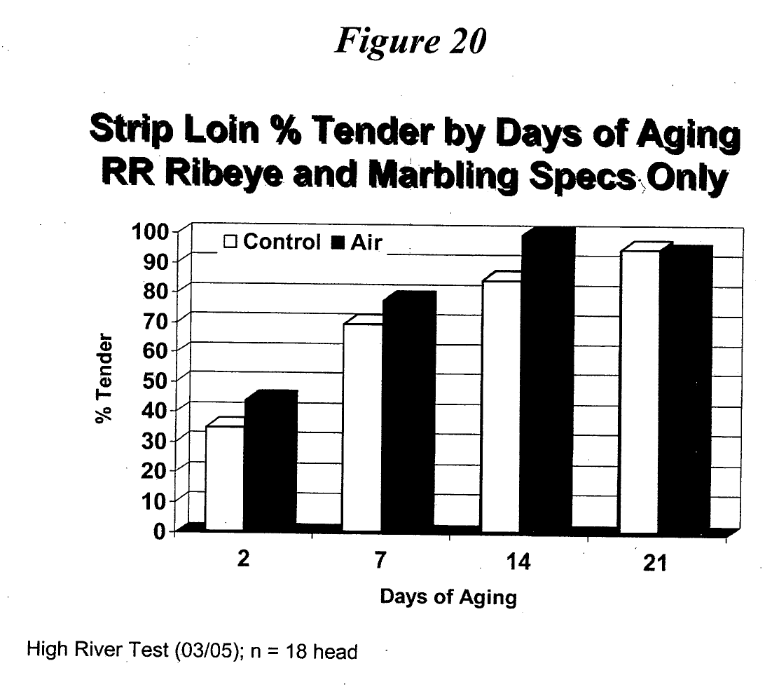

FIG. 20 graphically illustrates the results of Table 4. More specifically, Figure ______ graphically shows the percentage of strip loin tender by days of aging for RR ribeye and marbling carcasses only with the results shown for the control carcasses versus the air treated carcasses. Eighteen carcasses were evaluated.

TABLE 5
Top Butt Slice Shear Force, RR Ribeye and Marbling Specs Only

| Aging, d | Control | Air | Difference |
|---|---|---|---|
| 7 | 23.53 | 21.16 | −2.37* |
| 14 | 19.21 | 18367 | −0.54 |
| 21 | 17.67 | 15.65 | −2.02* |

*P < 0.09

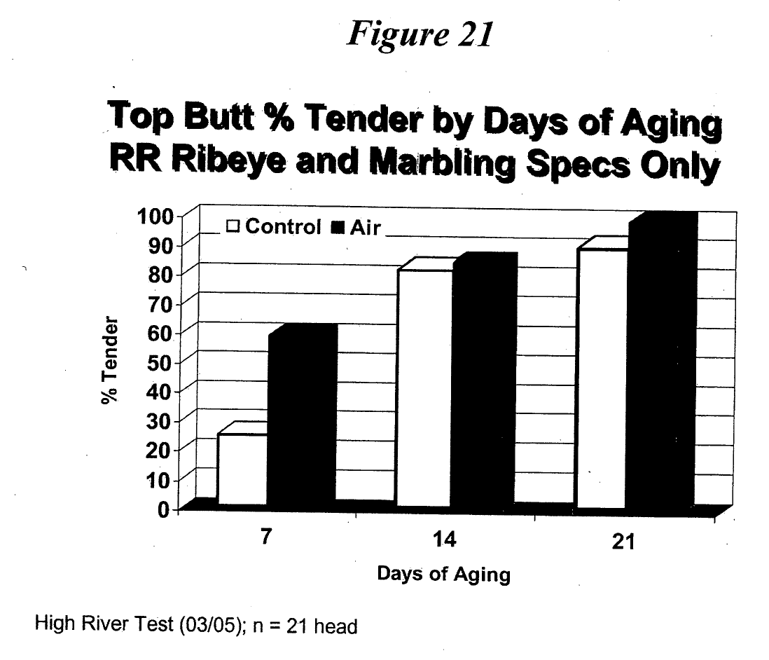

FIG. 21 graphically illustrates the results of Table 5. More specifically, Figure ______ graphically shows the percentage of top butt tender by days of aging for RR ribeye and marbling carcasses only with the results shown for the control carcasses versus the air treated carcasses. Twenty-one carcasses were evaluated.

While the system and method have been described with reference to injection of a compressed gas, it should be understood that other fluids, for example liquids, may be injected into the meat to tenderize the meat.

Although the invention has been described with reference to preferred embodiments, persons skilled in the art will recognize that changes may be made in form and detail without departing from the spirit and scope of the invention.

What is claimed is:

1. A method for tenderizing meat comprising making a first insertion by inserting at least one hollow elongate member into a portion of a pre-rigor carcass of an animal, the hollow elongate member including at least one opening for fluid passage, and injecting fluid into the carcass portion by pumping fluid into the first insertion through the hollow elongate member and out the at least one opening.

2. The method of claim 1, further comprising sterilizing the meat at the first insertion.

3. The method of claim 1, wherein the hollow elongate member is a needle.

3. The method of claim 1, wherein the carcass portion is a muscle or muscle group of the carcass.

4. The method of claim 3, wherein the muscle or muscle group is not cut from bone prior to injection of the fluid.

5. The method of claim 3, wherein the muscle or muscle group is cut from bone prior to injection of the fluid.

6. The method of claim 1, wherein the fluid is injected pre-rigor mortis.

7. The method of claim 6, wherein the fluid is injected approximately 24 hours after death of the animal.

8. The method of claim 6, wherein the fluid is injected approximately 12 hours after death of the anima.

9. The method of claim 1, further including sterilizing the needle.

10. The method of claim 1, wherein injecting fluid comprises injecting a gas.

11. The method of claim 10, wherein injecting fluid comprises injecting a mixture of gases.

12. The method of claim 1, wherein injecting fluid comprises injecting a liquid.

13. The method of claim 12, wherein injecting fluid comprises injecting the liquid under high pressure.

14. The method of claim 1, wherein the pumping is continued until a visible swell is noted in the portion of the carcass.

15. The method of claim 1, wherein the needle is removed and reinserted at a position spaced from the first insertion.

16. The method of claim 1, further comprising multiple removals and reinsertions of the hollow, elongate member for multiple injections of gas.

17. The method of claim 16, further comprising sterilizing the hollow, elongate member between removals and reinsertions.

18. A tenderized meat product comprising a meat product from a carcass portion wherein the carcass portion is tenderized by inserting at least one hollow, elongate member into the carcass portion, the member including at least one opening for fluid passage, and fluid is injected into the carcass portion by pumping gas through the member and out the at least one opening.

19. The tenderized meat product of claim 18, wherein the meat product includes an at least one injection passage from insertion of the at least one member.

20. End or thin meat portions having a slice shear force substantially consistent with that of a tenderized meat portion.

21. A meat portion comprising a tough cut of meat that includes connective tissue, the tough cut of meat having a slice shear force substantially consistent with that of a tenderized meat portion.

22. A meat portion comprising a tough cut of meat that includes fat, the tough cut of meat having a slice shear force substantially consistent with that of a tenderized meat portion.

23. A meat portion comprising a round muscle or muscle group that has a slice shear force substantially consistent with that of a tenderized meat portion.

24. An apparatus for meat tenderization comprising an injection apparatus and a sterilization assembly, the injection apparatus comprising at least one hollow, elongate member, the member having a forward end and a rearward end, a plurality of openings being provided along the member, the rearward end of each member being attached to a base, and a hose being operably attached to the base.

25. The apparatus of claim 24, wherein the sterilization assembly comprises a bellows assembly provided over at least a portion of a length of the member, the bellows assembly including a low pressure steam supply inlet proximate the rearward end of the member wherein a plate is provided proximate the forward end of the needle for capping the bellows assembly, the plate including at least one hole for expelling steam therethrough.26. The apparatus of claim 24, wherein the sterilization assembly comprises spring mount and current conductor for providing a cauterizing capability to the forward end of the member.
